(19) United States
(12) Patent Application Publication
(10) Pub. No.: US 2025/0089729 A1
(43) Pub. Date: Mar. 20, 2025

(54) MOLD FOR CREATING AN EDIBLE PRODUCT

(71) Applicant: Jonathan V. Clark, Wilmington, NC (US)

(72) Inventor: Jonathan V. Clark, Wilmington, NC (US)

(21) Appl. No.: 18/368,188

(22) Filed: Sep. 14, 2023

(51) Int. Cl. A21D 13/40; A21B 3/13; A21D 8/06; A21D 13/32; A23L 13/60; A47J 37/01

(52) U.S. Cl. CPC A21D 13/40; A21B 3/133; A21D 8/06; A21D 13/32; A23L 13/65; A47J 37/01

(57) ABSTRACT

The invention is an improved mold for producing a product (e.g., a hot dog bun). The mold includes a U-shaped base stabilized by supports at either end of the base. The mold further includes an arm positioned within the base cavity, thereby forming the unique shape to the produced bun. Advantageously, the product (e.g., hot dog bun) produced by the mold has a curved exterior configured to extend around a secondary product (e.g., a hot dog).

### TECHNICAL FIELD

The presently disclosed subject matter is generally directed to an improved mold for creating an edible or nonedible product, such as (but not limited to) a hot dog bun. The presently disclosed subject matter also includes methods of using the disclosed mold to create the product.

### BACKGROUND

The hot dog has been a staple of summer barbecues, county fairs, and sporting events for many decades. Hot dog buns are well known and are typically available prepackaged for retail purchase by the consumer. The buns are oblong in shape and are generally sold with a longitudinal slit so that the bun can be easily opened to receive a hot dog and condiments between the two halves. The slit does not fully extend through the bun, creating a hinge on one side. However, when the hot dog and condiments are placed within the bun, the bun has a tendency to break apart so that the two halves separate, making the hot dog difficult to eat. In addition, the action of inserting the hot dog into the bun often results in crumbling or breaking of the bun. During eating the hot dog, it is often difficult to get a good grip without mangling or destroying the bun. Further, it is not uncommon for the hot dog to slip out of the bun while it is being eaten. It would therefore be beneficial to provide an improved hot dog bun that allows for easy gripping by the consumer and provides increased stability to prevent crumbling and breaking.

### SUMMARY

In some embodiments, the presently disclosed subject matter is directed to a mold for producing a product. Specifically, the mold comprises a base defined by a bottom edge, pair of sidewalls that extend upward from the bottom edge, a first end and an opposed second end, an inner cavity in fluid connection with an upper opening, and a lip positioned on an upper edge of each side edges extending away from the inner cavity. The mold further includes a pair of supports positioned adjacent to the first and second ends of the base, wherein each support includes a bottom edge, a pair of side edges, and an upper edge defined by an elongated cutout that extends downward towards the bottom edge. The mold incudes an arm comprising a first end, a second end, and a length therebetween, wherein the first and second arm ends are positioned within the support cutouts and the arm length spans the base cavity.

In some embodiments, the base is configured in a U-shape.

In some embodiments, each lip is configured at an angle of about 45 degrees relative to the adjacent sidewall.

In some embodiments, the base has a height that is less than the height of the supports.

In some embodiments, each support cutout includes an oval or rounded circumference.

In some embodiments, the arm is removably positioned within the support cutouts.

In some embodiments, the base, supports, and arm are constructed from metal, plastic, stone, ceramics, wood, or combinations thereof.

In some embodiments, the presently disclosed subject matter is directed to a method of producing a product using the disclosed mold. Specifically, the method comprises positioning a first form of the product within the base cavity, positioning the first and second arm ends within the support cutouts such that the arm length spans the base cavity, and subjecting the first form of the product to a treatment within the mold, wherein the product converts to a second form and extends around and above the arm as a result of the treatment. The second form of the product includes a pair of side edges, first and second ends, and wherein each side edge includes a pair of curves separated by an indentation and a central cavity in fluid communication with an upper opening, wherein the width of the product central cavity is greater than the width of the product upper opening.

In some embodiments, the first condition is the application of heat to bake the first form of the product.

In some embodiments, each lip is configured at an angle of about 45 degrees relative to the adjacent sidewall.

In some embodiments, the product is an edible product.

In some embodiments, the edible product is a hot dog bun.

In some embodiments, the product central cavity has a round or oval cross-sectional shape.

In some embodiments, the product central cavity extends from the product first end to the product second end.

In some embodiments, the presently disclosed subject matter is directed to a product produced by the disclosed method, wherein the product is defined by first and second ends, a pair of side edges, each side edge including a pair of curves separated by an indentation, and a central cavity in fluid communication with an upper opening, wherein the width of the product central cavity is greater than the width of the product upper opening and wherein the central cavity extends from the first end to the second end of the product.

### BRIEF DESCRIPTION OF THE DRAWINGS

FIG. 1 is a perspective view of a mold for producing a product in accordance with some embodiments of the presently disclosed subject matter.

FIG. 2a is a side plan view of a mold base in accordance with some embodiments of the presently disclosed subject matter.

FIG. 2b is a front plan view of a mold base in accordance with some embodiments of the presently disclosed subject matter.

FIG. 2c is a fragmentary view of a mold base sidewall comprising an upper lip in accordance with some embodiments of the presently disclosed subject matter.

FIG. 2d is a top plan view of a mold base in accordance with some embodiments of the presently disclosed subject matter.

FIG. 3a is a front plan view of a mold support in accordance with some embodiments of the presently disclosed subject matter.

FIG. 3b is a top plan view of a mold support in accordance with some embodiments of the presently disclosed subject matter.

FIG. 4a is a perspective view of a mold arm in accordance with some embodiments of the presently disclosed subject matter.

FIG. 4b is a front plan view of a mold arm in accordance with some embodiments of the presently disclosed subject matter.

FIG. 5a is a top plan view of an assembled mold in accordance with some embodiments of the presently disclosed subject matter.

FIG. 5b is a front cutaway view of an assembled mold in accordance with some embodiments of the presently disclosed subject matter.

FIG. 6a is a perspective view of a product produced by a mold in accordance with some embodiments of the presently disclosed subject matter.

FIG. 6b is a top plan view of a product produced by a mold in accordance with some embodiments of the presently disclosed subject matter.

FIG. 6c is a front plan view of a product produced by a mold in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

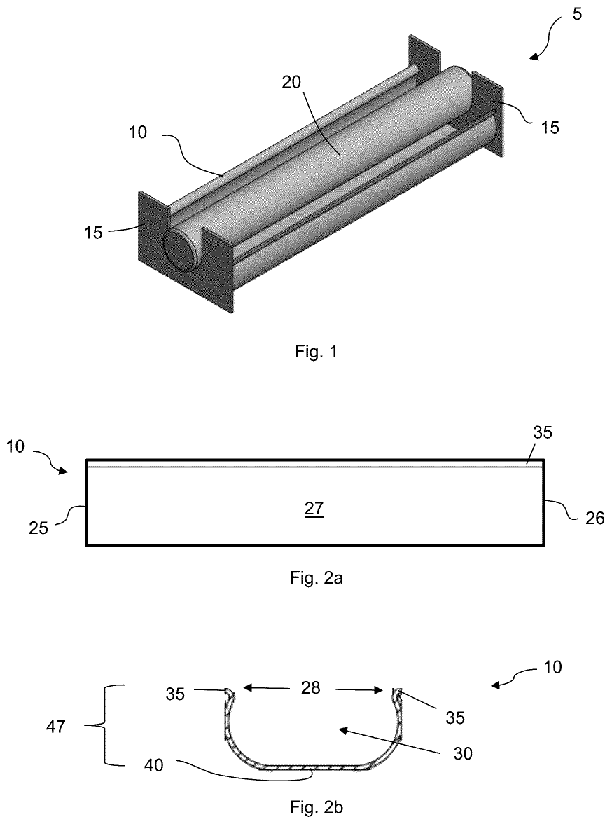

The presently disclosed subject matter is directed to an improved mold for producing a product (e.g., a hot dog bun). The term “mold” broadly refers to a solid support used to hold a substrate that transfers a particular shape to the substrate. For example, the disclosed mold can be used to form a hot dog bun that efficiently holds a hot dog. However, it should be appreciated that the molded product is not limited to a bun or bread product and any suitable product can be molded. FIG. 1 illustrates one embodiment of mold 5 comprising U-shaped base 10 stabilized by supports 15 at either end of the base. The mold further includes arm 20 positioned within the base cavity, thereby forming the unique shape to the produced bun. Advantageously, the product (e.g., hot dog bun) produced by mold 5 has a curved exterior configured to extend around a secondary product (e.g., a hot dog), as described in detail below. However, the presently disclosed subject matter is not limited and the mold can be used to produce any suitable product, edible or non-edible.

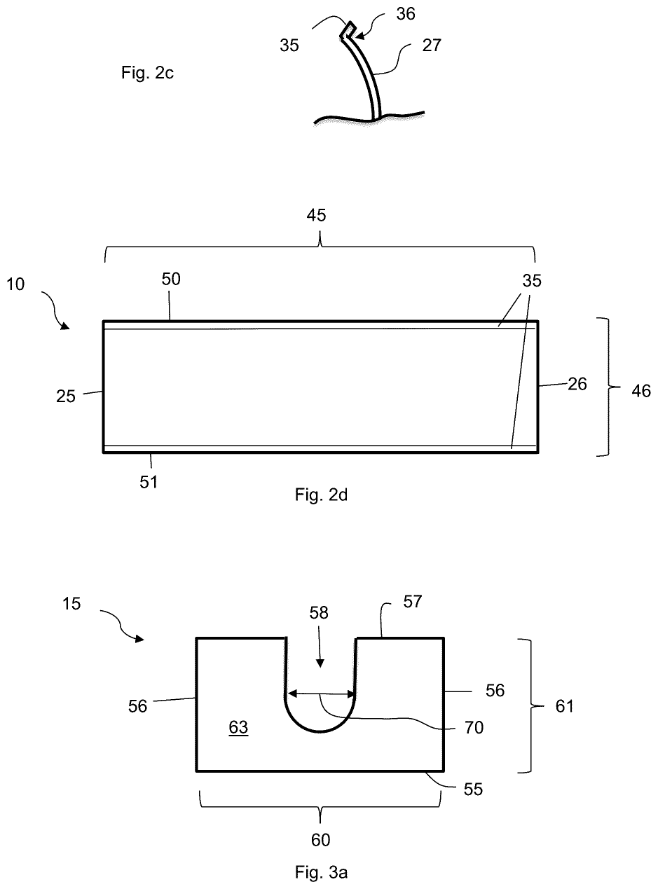

As noted, mold 5 includes base 10, as illustrated in FIGS. 2a-2b. Particularly, the base includes first end 25 and opposed second end 26. The base further includes sidewall 27 that is curved into a U or C shape with opening 28 at the top of the base to create cavity 30 that is sized and shaped to accommodate arm 20. The sidewall further includes horizontal bottom edge 40, allowing the base to stably rest on a support surface. Thus, the sidewall is configured with a horizontal bottom edge 40 that extends upward on either side with two side edges that curve outward and then extend back in (e.g., an inverted “C” shape). The top edge of sidewall 27 includes lip 35 that extends away from the midpoint of the base, as shown in FIG. 2b. The lip provides added support for the base and directs the first formed product to have an indented final shape, which can be efficient for holding and gripping the final produced product (e.g., bun).

Lip 35 can have any suitable angle relative to the sidewall, such as about 45 degrees, as shown in FIG. 2c. Thus, angle 36 can be at least about (or no more than about) 15, 20, 25, 30, 35, 40, 45, 50, 55, 60, 65, 70, 75, 80, 85, or 90 degrees relative to the sidewall.

Base 5 can include length 45 of about 5-15 inches (e.g., at least/no more than about 5, 5.5, 6, 6.5, 7, 7.5, 8, 8.5, 9, 9.5, 10, 10.5, 11, 11.5, 12, 12.5, 13, 13.5, 14, 14.5, or 15 inches). The term “length” refers to the longest horizontal distance of the base (e.g., from first end 25 to second end 26). The base can further include width 46 of about 1-5 inches (e.g., at least/no more than about 1, 1.5, 2, 2.5, 3, 3.5, 4, 4.5, or 5 inches), as shown in FIG. 2d. The term “width” refers to the longest straight line distance perpendicular to the length (e.g., from first side edge 50 to opposed side edge 51). The base can further include height 47 of about 0.5-5 inches (e.g., at least/no more than about 0.5, 1, 1.5, 2, 2.5, 3, 3.5, 4, 4.5, or 5 inches). The term “height” refers to the longest straight line distance from bottom edge 40 to the uppermost, opposed edge. It should be appreciated that the base length, width, and height are not limited and can be configured greater or less than the ranges given above.

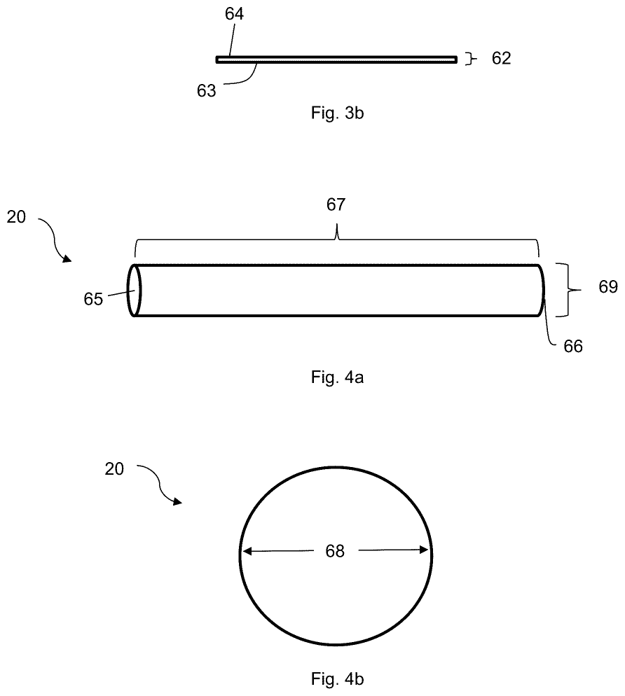

The first and second ends of the base join with supports 15 that add reinforcement to the base, preventing it from moving and allowing the base to securely rest on a solid surface. As shown in FIG. 3a, each support includes horizontal bottom edge 55 that allows the support to rest on a solid surface. The support further includes a pair of side edges 56 and upper edge 57 comprising elongated cutout 58 that extends downward towards the first edge. The cutout is sized and shaped to accommodate arm 20 at the proper height and position to produce a final product (e.g., bun). The supports also function to restrain the dough within the base as the dough is being cooked when the mold is used to form a hot dog bun.

In some embodiments, each support can have length 60 of about 1-5 inches (e.g., at least/no more than about 1, 1.5, 2, 2.5, 3, 3.5, 4, 4.5, or 5 inches), as shown in FIG. 3a. In some embodiments, each support includes width 61 of about 1-5 inches (e.g., at least/no more than about 1, 1.5, 2, 2.5, 3, 3.5, 4, 4.5, or 5 inches). Each support can further include thickness 62 of about 0.01-0.5 inches (e.g., the distance between front surface 63 and opposed rear surface 64), as shown in FIG. 3b. Cutout 57 can have width 70 of about 0.5-3 inches (e.g., at least/no more than about 0.5, 1, 1.5, 2, 2.5, or 3 inches). It should be appreciated that the support length, width, and thickness are not limited and can be configured greater or less than the ranges given above.

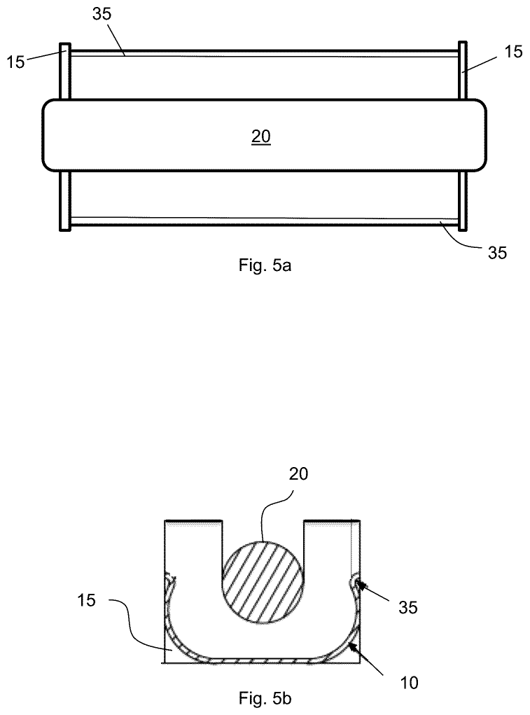

As noted above, mold 5 further includes arm 20 configured to rest within the base cavity and extend to contact cutout 57 on each support 15. The arm is a solid element to give weight to the mold such that the produced product (e.g., bun) is formed around the arm. As shown in FIG. 4a, the arm includes first and second ends 65, 66 and length 67 that extends therebetween. Length 67 can be about 5-10 inches (e.g., at least/no more than about 5, 5.5, 6, 6.5, 7, 7.5, 8, 8.5, 9, 9.5, or 10 inches). The arm can further include width 68 and height 69 of about 0.5-3 inches (e.g., at least/no more than about 0.5, 1, 1.5, 2, 2.5, or 3 inches), as shown in FIG. 4b.

Arm 20 can have a circular or oval cross-sectional shape, which can be useful when producing a bun that will accommodate a circular product (such as a hot dog). However, the arm can have any desired cross-sectional shape (e.g., square, rectangular, triangular, diamond, heart, abstract).

The mold base, support, and arm can be constructed from any suitable rigid material. The term “rigid” refers to a material capable of holding its original shape upon the application of pressure. For example, metal (e.g., stainless steel, steel, aluminum, copper), plastic, stone, ceramics, wood, or combinations thereof can be used. Thus, where heat is to be applied to the mold, sheet metal material, ceramics, and/or stone can be used. For non-heat applications of the mold, other rigid materials (e.g., wood, plastic) can be used.

In some embodiments, the mold (or portions of the mold, such as the base cavity) can include a nonstick coating, such as Teflon® and the like to ensure that the produced product can be easily removed from the mold.

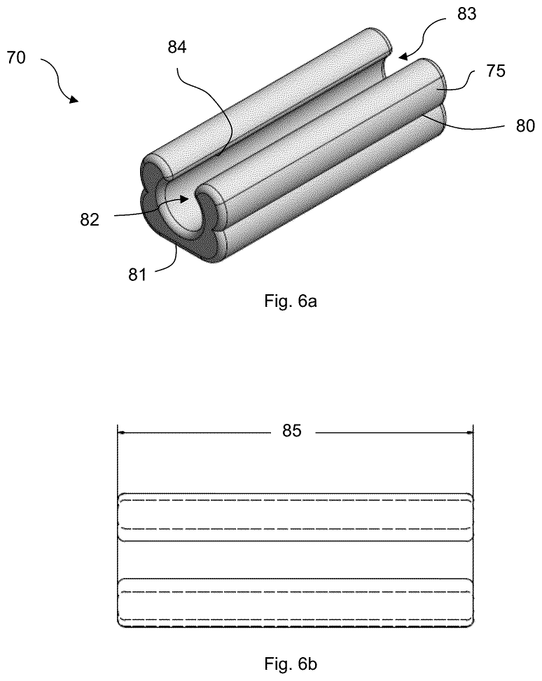

To assemble the mold, base 10 is positioned such that the first and second base ends abut supports 15. In this way, the base is stabilized and can easily and securely rest on a support surface, such as a table or the floor. In some embodiments, base and supports 15 are constructed as a single unit. In other embodiments, base 10 attaches to the supports using adhesive, welding, magnets, clips, screws, bolts, fasteners, or any other element. As shown in FIGS. 5a and 5b, arm 20 is positioned within base cavity 30 and is supported at a height above the lower base edge by support cutouts 58. In this way, there is a space between the lower edge of the arm and the lower edge of the base for the produced product (e.g., bun) to properly form.

In use, the mold can be used to create product 70. In some embodiments, product 70 is an edible product. The term “edible product” refers to any product that can be eaten or consumed by a human or animal. Thus, the edible product can include a bread product (e.g., hot dog bun), although any edible product can be selected. For example, when product 70 is a hot dog bun, dough can be placed within the cavity of the mold base, resting on the bottom surface of the base cavity. After the raw first product has been added to the base, arm 20 can be configured within the base and a treatment can then be performed on the mold. For example, heat can be applied to the mold to bake the dough, forming a hot dog bun or other product. Product 70 can extend around and above arm 20 as it cooks providing, an improved shape that includes an easy-grip feature. Thus, the mold can be placed into an oven (or placed on a baking plan and inserted into an oven). During baking, the dough rises and conforms around the base cavity and arm, forming the shape discussed below.

After product 70 has been prepared (e.g., cooked), it can be removed from the mold using any suitable method. For example, product 70 can slide out from the mold. Alternatively, the mold can be fully or partially disassembled (e.g., arm 20 can be removed to lift out the product from the base cavity). The process can be repeated to prepare additional products 70.

It should be appreciated that mold 5 can be used for a variety of heat and non-heat applications. For example, the mold can be baked, microwaved, or otherwise exposed to a direct or indirect heat source. Alternatively, the mold can be used for air or sun drying, without direct heat exposure. Similarly, mold 5 can be used as a proofing stand for yeast-baked dough prior to baking. Further, the mold can be used in a press and release sequence that forms traditional dough into a desired shape prior to the baking step.

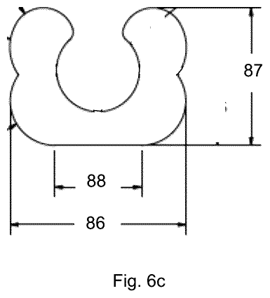

One embodiment of product 70 is illustrated in FIGS. 6a-6c. As shown, the product includes a continuous item with no slices or cuts. The product comprises a pair of curved outer edges 75 (e.g., a pair of double C-shapes on each side). Edges 75 each include indentation 80 that advantageously allows a user to easily grasp and retain the product when in use. The indentation is formed by base lip 35, as the product extends around and over the base during cooking or otherwise while being formed. Stated another way, when product 70 is a bun, the bun expands within the interior of the base cavity, extending above the base and around arm 20, such that lip 35 creates a central indentation on each side.

The product also includes flat bottom edge 81 that allows a user to rest the product on a surface, such as a horizontal table or plate. Product 70 includes cavity 82 in communication with product opening 83 configured at the top edge of the product. The cavity is formed by arm 20, as the product expands around the arm when it is formed (e.g., baked or otherwise processed). The product cavity and upper opening allow a second product (e.g., hot dog) to be inserted into cavity 82 if desired by the user. Importantly, the diameter of the product cavity is greater than the width of upper opening 83, which ensures that the hot dog cannot easily be dislodged from the product. Specifically, when a hot dog is inserted into the product cavity, it resists movement because the area adjacent to opening 83 grips the hot dog and keeps it properly positioned. As a result, the hot dog is less likely to move or escape from cavity 82. In addition, the user grips product 70 at indentation 80 which further squeezes and maintains the hot dog in proper position within cavity 82. It should be noted that a hot dog is one example of an item that can be inserted into the product cavity, although any of a wide variety of items can be used.

Product 70 can have length 85 of about 5-10 inches (e.g., at least/no more than about 5, 5.5, 6, 6.5, 7, 7.5, 8, 8.5, 9, 9.5, or 10 inches). The first product can further include width 86 and height 87 of about 1-5 inches (e.g., at least/no more than about 1, 1.5, 2, 2.5, 3, 3.5, 4, 4.5, or 5 inches). The product cavity can include width 88 of about 0.5-3 inches (e.g., at least/no more than about 0.5, 1, 1.5, 2, 2.5, or 3 inches). As noted above, the product cavity width is less than the width of opening 83 (e.g., about 5, 10, 15, 20, 25, 30, 35, 40, 45, or 50 percent less in some embodiments).

The disclosed mold offers many advantages over prior art molds. For example, the mold can be used with a wide variety of edible and non-edible products.

The mold is easy to use, allowing even children or the elderly to efficiently produce product 70.

The mold can be effectively used to create product 70. Advantageously, the first product includes indentation 80, allowing it to be grasped between the fingers, thereby reducing the incidence of dropping the product or a hot dog (or other item) configured within the product cavity.

Product 70 also includes a flat lower surface, allowing it to be easily positioned on a support surface when not being used.

The produced product is resistant to breakage and crumbling compared to prior art products (e.g., prior art hot dog buns) because it lacks the conventional slit to accommodate a hot dog.

The disclosed mold enables the production of product 70, which includes a U-shaped cavity that molds around a hot dog or other product, better containing the hot dog and any desired condiments.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

What is claimed is:

1. A mold for producing a product, the mold comprising:
a base defined by a bottom edge, pair of sidewalls that extend upward from the bottom edge, a first end and an opposed second end, an inner cavity in fluid connection with an upper opening, and a lip positioned on an upper edge of each side edges extending away from the inner cavity;
a pair of supports positioned adjacent to the first and second ends of the base, wherein each support includes a bottom edge, a pair of side edges, and an upper edge defined by an elongated cutout that extends downward towards the bottom edge;
and an arm comprising a first end, a second end, and a length therebetween, wherein the first and second arm ends are positioned within the support cutouts and the arm length spans the base cavity.

2. The mold of claim 1, wherein the base is configured in a U-shape.

3. The mold of claim 1, wherein each lip is configured at an angle of about 45 degrees relative to the adjacent sidewall.

4. The mold of claim 1, wherein the base has a height that is less than the height of the supports.

5. The mold of claim 1, wherein each support cutout includes an oval or rounded circumference.

6. The mold of claim 1, wherein the arm is removably positioned within the support cutouts.

7. The mold of claim 1, wherein the base, supports, and arm are constructed from metal, plastic, stone, ceramics, wood, or combinations thereof.

8. A method of producing a product using the mold of claim 1, the method comprising:
positioning a first form of the product within the base cavity;
positioning the first and second arm ends within the support cutouts such that the arm length spans the base cavity;
subjecting the first form of the product to a treatment within the mold, wherein the product converts to a second form and extends around and above the arm as a result of the treatment;
wherein the second form of the product includes a pair of side edges, first and second ends, and wherein each side edge includes a pair of curves separated by an indentation and a central cavity in fluid communication with an upper opening, wherein the width of the product central cavity is greater than the width of the product upper opening.

9. The method of claim 8, wherein the first condition is the application of heat to bake the first form of the product.

10. The method of claim 8, wherein each lip is configured at an angle of about 45 degrees relative to the adjacent sidewall.

11. The method of claim 8, wherein the product is an edible product.

12. The method of claim 9, wherein the edible product is a hot dog bun.

13. The method of claim 8, wherein the product central cavity has a round or oval cross-sectional shape.

14. The method of claim 8, wherein the product central cavity extends from the product first end to the product second end.

15. A product produced by the method of claim 8, wherein the product is defined by first and second ends, a pair of side edges, each side edge including a pair of curves separated by an indentation, and a central cavity in fluid communication with an upper opening, wherein the width of the product central cavity is greater than the width of the product upper opening and wherein the central cavity extends from the first end to the second end of the product.

16. The product of claim 15, wherein the product is an edible product.

17. The edible product of claim 16, wherein the product is a hot dog bun.

18. The product of claim 13, further comprising a hot dog configured within the product central cavity.

19. The product of claim 13, defined by a flat bottom edge.
